(19) United States
(12) Patent Application Publication
(10) Pub. No.: US 2024/0230020 A9
(43) Pub. Date: Jul. 11, 2024

(54) DEVICE MOUNTS

(71) Applicant: Hewlett-Packard Development Company, L.P., Spring, TX (US)

(72) Inventors: Joseph Roy Torretto, Taipei City (TW); Li-Pang Liang, Taipei City (TW); Hung-Chang Chen, New Taipei City (TW); Chang-I Chen, Taipei City (TW); John W. Frederick, Spring, TX (US)

(21) Appl. No.: 17/971,430

(22) Filed: Oct. 21, 2022

(51) Int. Cl. F16M 11/12; F16M 11/04

(52) U.S. Cl. CPC F16M 11/125; F16M 11/041

(57) ABSTRACT

In some examples, a mount includes a mounting plate. In some examples, the mounting plate includes mounting holes disposed in a rectangular pattern on the mounting plate to mount a device to the mounting plate. In some examples, the mount includes an adjustment mechanism disposed within a depression of the mounting plate. In some examples, the mount includes a coupler to couple the mounting plate to a support.

### BACKGROUND

Some electronic devices may be attached to stands or walls. For instance, a television may be attached to a wall using a bracket. In some cases, brackets or attachment solutions may occupy a relatively large amount of space, which may consume more room and/or desk space, etc. Some brackets or attachment solutions may expose cables, thereby resulting in a cluttered appearance.

### BRIEF DESCRIPTION OF THE DRAWINGS

FIG. 1 is a diagram illustrating a back elevation view of an example of a mount;

FIG. 2 is a diagram illustrating an exploded view of an example of a mount;

FIG. 3 is a diagram illustrating a side elevation view of an example of a mount;

FIG. 4 is a diagram illustrating a back perspective view of an example of a display housing, a mount, a first cover, and a second cover;

FIG. 5 is a diagram illustrating an exploded back perspective view of an example of a display housing, a device holding bracket, a device, a mount, and a stand; and

FIG. 6 is a diagram illustrating a side elevation view of the components of FIG. 5.

### DETAILED DESCRIPTION

A mount is a structure to attach to an object and/or to support an object. For example, an electronic device may be mounted to a mount to support (e.g., hold) the electronic device in a location. In some examples, a mount may be utilized to attach an electronic device to a ceiling, wall, floor, support base (e.g., foot), stand, furniture, cart, vehicle, etc. For instance, a television may be attached to a wall by a mount, a monitor may be attached to a stand (e.g., foot) by a mount, a monitor may be attached to a desk by a mount, etc. A mount may be fabricated from metal(s), plastic(s), organic material(s), and/or another material(s).

Throughout the drawings, similar reference numbers may designate similar or identical elements. When an element is referred to without a reference number, this may refer to the element generally, without limitation to any particular drawing or figure. In some examples, the drawings may not be to scale and/or the size of some parts may be exaggerated to more clearly illustrate the example shown. Moreover, the drawings provide examples in accordance with the description. However, the description is not limited to the examples provided in the drawings.

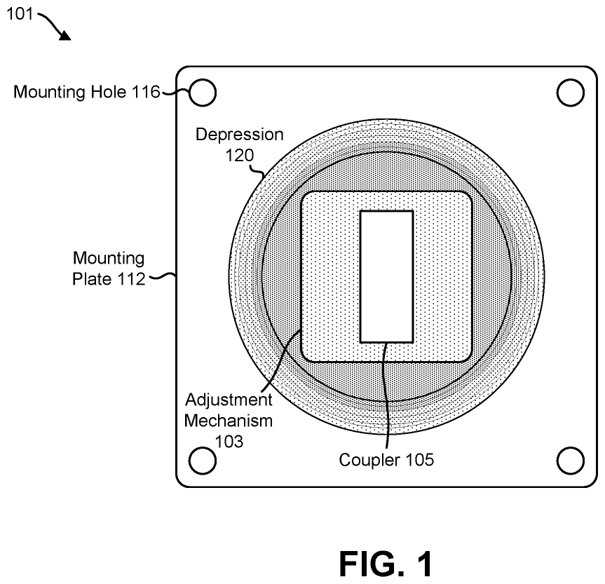

FIG. 1 is a diagram illustrating a back elevation view of an example of a mount 101. The mount 101 includes a mounting plate 112. A mounting plate is a structure to attach to an object (e.g., device, electronic device, monitor, television, computer, etc.) with a fastener(s). In the example of FIG. 1, the mounting plate 112 includes mounting holes (e.g., mounting hole 116) disposed in a rectangular pattern on the mounting plate 112 to mount an object (e.g., device) to the mounting plate 112. For instance, mounting holes disposed in a rectangular pattern are mounting holes located at the corners (e.g., four corners) of a rectangular shape. For example, a mounting hole may be centered at each corner of a rectangle shape. A mounting hole is a channel (e.g., a channel through a mounting plate) for a fastener. In some examples, mounting holes (e.g., channels, passages, tunnels, cylindrical shafts, etc.) may permit passage of mounting fasteners to attach an electronic device to a mount. For instance, the mounting hole 116 may permit a fastener (e.g., screw, nail, rivet, stud, anchor, etc.) to pass through the mounting plate 112 and to hold (e.g., mount) an object (e.g., electronic device) to the mounting plate 112. In some examples, additional hardware (e.g., washer(s), rubber spacer(s), and/or nut(s), etc.) may be utilized with a mounting fastener.

An electronic device is a device that includes electronic circuitry (e.g., integrated circuitry, a chip(s), etc.). Examples of electronic devices may include monitors, televisions, display devices, display panels, computing devices, game consoles, etc. Some examples of electronic devices may utilize circuitry (e.g., controller(s) and/or processor(s), etc.) to perform an operation or operations. In some examples, electronic devices may execute instructions stored in memory to perform the operation(s). Instructions may be code and/or programming that specifies functionality or operation of the circuitry. In some examples, instructions may be stored in memory (e.g., Random-Access Memory (RAM), Read-Only Memory (ROM), Erasable Programmable Read-Only Memory (EPROM), Electrically Erasable Programmable Read-Only Memory (EEPROM), flash memory, dynamic random-access memory (DRAM), synchronous DRAM (SDRAM), magnetoresistive random-access memory (MRAM), phase-change random-access memory (PCRAM), hard disk drive (HDD), solid state drive (SSD), optical drive, etc.).

In some examples, the mounting holes may conform to a Video Electronics Standards Association (VESA) profile (e.g., VESA Mounting Interface Standard (MIS), VESA MIS-D, VESA MIS-E, VESA MIS-F, etc.). A VESA profile indicates a distance(s) between holes (e.g., mounting holes, threaded holes in an electronic device, etc.). Examples of VESA profiles include (in horizontal distance×vertical distance in millimeters (mm)): 75×75, 100×100, 200×200, 300×300, 400×400, 1000×800, 800×600, 800×400, 700×400, 300×200, 400×200, 200×100, 400×300, 600×200, 600×400, etc.

A mounting fastener is a fastener to mechanically hold objects (e.g., the mounting plate 112 and a device) together. As used herein a “screw” may denote a fastener with threads (e.g., spiral groove, helical groove, etc.) disposed along a dimension of the fastener. For instance, a “screw” may denote a threaded cylindrical fastener without a pointed end (e.g., a bolt) and/or a threaded fastener with a pointed end (e.g., a tapered end). In some examples, a screw includes a threaded portion along a rotational axis and a head that is larger than the threaded portion in a direction perpendicular to the rotational axis. For instance, a threaded portion of a screw may be sized to pass through the mounting hole 116 and the head may be sized to not pass through the mounting hole 116 (e.g., to hold the mounting plate 112 against an object that the screw is disposed within). A mounting hole may be circular, square, hexagonal, etc., or may have another shape.

In some examples, a mounting fastener may be utilized to mount a device (e.g., electronic device) to a mount (e.g., mount 101) semi-permanently or permanently. For instance, a mounting fastener may disallow (e.g., prevent, restrict, etc.) unmounting without removal of the mounting fastener. For example, an electronic device (e.g., monitor, television, computer, etc.) may not be unmounted from the mounting plate 112 without removing each mounting fastener(s) attached to the electronic device through the mounting plate 112. In some examples, when an object is mounted to the mounting plate 112, the mounting plate 112 may not facilitate removal of the object and/or detachment of the object from the mounting plate 112 without fastener removal.

The mounting plate 112 may include a depression 120. The depression 120 is an indentation or recess in the mounting plate 112. For instance, the depression 120 may form a second level of the mounting plate 112 at a different depth than a first level of the mounting plate 112 that includes the mounting holes. In some examples, the depression 120 may indent in a direction perpendicular to a surface that includes the mounting holes. For example, the depression 120 may indent (and/or protrude) in an object mounting direction. For instance, the depression 120 may indent in an axial direction of the mounting holes (e.g., mounting hole 116) and/or in an axial direction of a fastener to pass through a mounting hole (e.g., towards a device to be attached to the mounting plate 112).

In the example of FIG. 1, the depression 120 is circular in shape with a sloping region between the first level where the mounting holes are located and a second level. In some examples, a depression may be circular, rectangular, elliptical, or irregular in shape. In some examples, a depression may transition between levels with a smooth slope or with a sharp (e.g., perpendicular, right angular) transition.

The mount 101 may include an adjustment mechanism 103. An adjustment mechanism is a mechanism to allow position and/or orientation adjustment. For instance, the adjustment mechanism 103 may allow the mounting plate 112 and/or an attached object (e.g., device) to be adjusted in position and/or orientation relative to a support (e.g., stand, mounting arm, wall bracket, etc.).

In some examples, the adjustment mechanism 103 may be disposed within the depression 120 of the mounting plate 112. For instance, the adjustment mechanism 103 may be partially or completely disposed below an outer or top surface of the mounting plate 112 (e.g., below the surface of the mounting plate 112 that includes the mounting holes). In some examples, the adjustment mechanism 103 may be disposed on a back side of the mounting plate 112 (e.g., on an opposite side from a side where an object or device is to be mounted).

In some examples, the adjustment mechanism 103 includes a tilt bracket(s) disposed within the depression 120 of the mounting plate 112. A tilt bracket is a structure that is moveable (e.g., rotatable) in a range of pitch angles (e.g., ±45° for tilting upwards or downwards). For instance, a tilt bracket may allow adjustment of a pitch angle of the mounting plate 112 (and/or an attached object). In some examples, a single tilt bracket or multiple tilt brackets (e.g., a left-side tilt bracket and a right-side tilt bracket) may be included in the adjustment mechanism 103.

In some examples, the adjustment mechanism 103 includes a pivot bracket disposed within the depression 120 of the mounting plate 112. A pivot bracket is a structure that is moveable (e.g., rotatable) in a range of roll angles (e.g., 0-90° for landscape or portrait orientation). For instance, a pivot bracket may allow adjustment of a roll angle of the mounting plate 112 (and/or an attached object).

In some examples, the adjustment mechanism 103 includes a swivel bracket disposed within the depression 120 of the mounting plate 112. A swivel bracket is a structure that is moveable (e.g., rotatable) in a range of yaw angles (e.g., ±90° for side-to-side adjustment). For instance, a swivel bracket may allow adjustment of a yaw angle of the mounting plate 112 (and/or an attached object). In some examples, an adjustment mechanism(s) may be disposed separate from the mount 101. For instance, a tilt, pivot, and/or swivel mechanism(s) may be provided on a support (e.g., stand) coupled to the mount 101.

In some examples, the adjustment mechanism 103 may include a combination of adjustment mechanisms (e.g., tilt, pivot, and/or swivel mechanisms). For instance, a pivot bracket may be attached to two tilt brackets. The pivot bracket and two tilt brackets may provide pivot and tilt adjustments.

The mount 101 may include a coupler 105. The coupler 105 is a structure to couple the mount 101 to a support (e.g., stand, bracket, arm, etc.). As used herein, the term “couple” and variations thereof may denote a direct attachment (without an intervening component(s)) or an indirect attachment (with an intervening component(s)). The coupler 105 may couple the mounting plate 112 to a support.

In some examples, the coupler 105 is coupled to the adjustment mechanism 103. For instance, the coupler 105 may be mechanically coupled and/or fastened to the adjustment mechanism 103 (e.g., fastened to the adjustment mechanism 103 using a fastener(s)). In some examples, the mount 101 may include a coupler sleeve disposed on the coupler 105. The coupler sleeve may interface with the support. For instance, the sleeve may fit within a mounting socket (e.g., bay, port, etc.) of the support. In some examples, the sleeve may include an attachment mechanism (e.g., tab(s), spring-loaded button(s), etc.). The attachment mechanism may allow for attachment to the support and/or detachment (e.g., quick release) from the support.

In some examples, the mount 101 may include a cover (not shown in FIG. 1). The cover may be disposed over the depression 120. For instance, the cover may be disposed over the depression 120 to partially or completely cover the adjustment mechanism 103. In some examples, the coupler 105 may be disposed through the cover. For instance, the cover may include a channel (e.g., rectangular channel) to allow the coupler to protrude through the cover.

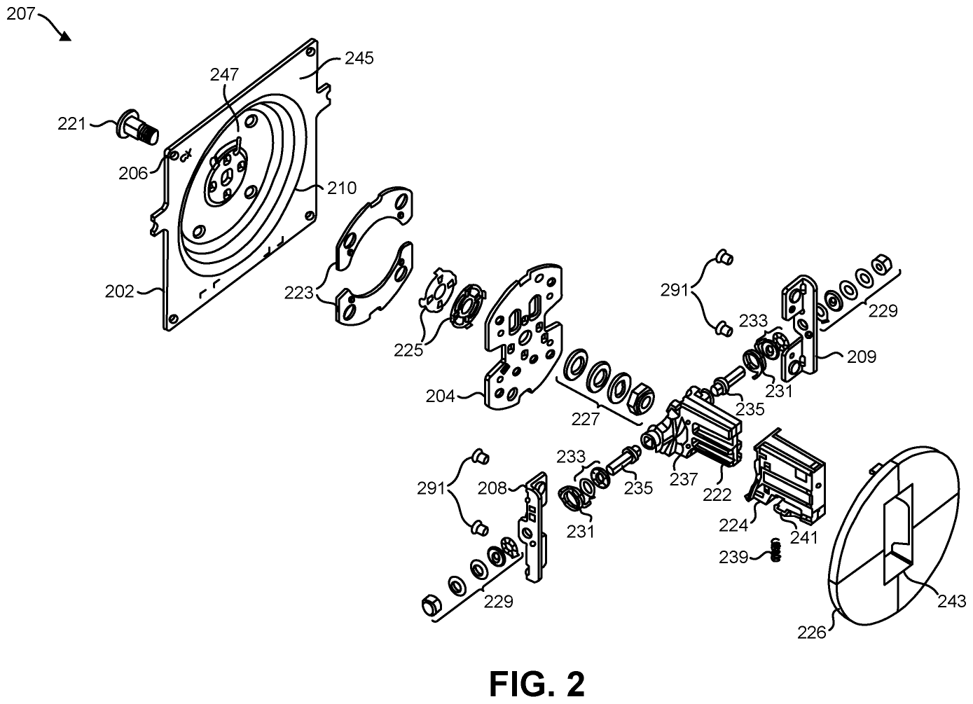

FIG. 2 is a diagram illustrating an exploded view of an example of a mount 207. The mount 207 may be an example of the mount 101 described in relation to FIG. 1. The mount 207 may include a mounting plate 202, a pivot bracket 204, tilt brackets 208, 209, a coupler 222, a coupler sleeve 224, and/or a cover 226. The mounting plate 202, pivot bracket 204, tilt brackets 208, 209, coupler 222, coupler sleeve 224, and/or cover 226 may be examples of corresponding components described in relation to FIG. 1. For instance, the mounting plate 202 may include mounting holes (e.g., mounting hole 206). In some examples, the mounting plate 202 may include a protrusion or protrusions. For instance, the mounting plate 202 in FIG. 2 includes two protrusions (e.g., ears) that protrude transversely beyond a rounded rectangular shape of the mounting plate 202. The mounting plate 202 may include a first level 245 (e.g., a level including the mounting holes, a level including a top or outer surface, etc.). The mounting plate 202 may include a depression 210. The mounting plate 202 may include a second level 247 (e.g., a lower level, an inner surface, etc.).

In some examples, the mount 207 may include a pivot bolt 221, interface plates 223, pivot rings 225, pivot hardware 227 (e.g., a nut and washers), outer tilt hardware 229 (e.g., nuts and washers), tilt springs 231, inner tilt hardware 233 (e.g., washers), tilt bolts 235, screws 291, and/or coupler spring 239. In some examples, a component(s) described in relation to FIG. 2 may be omitted from the mount 207, combined, or substituted.

In some examples, the interface plates 223 may interface between the mounting plate 202 and the pivot bracket 204. In some examples, the pivot rings 225 may respectively interface with the mounting plate 202 and the pivot bracket 204. The pivot rings 225 may rotate (e.g., pivot) relative to each other and/or may include features to provide mechanical resistance at a pivot setting(s) (e.g., 90° increment(s)). In some examples, a component(s) (e.g., the interface plates 223, the pivot rings 225, and/or the pivot bracket 204) may include a mechanical feature(s) (e.g., post(s), tab(s), etc.) to limit a pivot range (e.g., 0-90°, ±90°, etc.).

The pivot bolt 221 may include a keyed shaft (to align with a mounting plate pivot hole and/or a keyed washer of the pivot hardware 227), a smooth shaft portion (to allow rotation), and a threaded shaft portion (to hold a nut of the pivot hardware 227). The pivot bolt 221 and pivot hardware 227 may couple the pivot bracket 204 to the mounting plate 202 and allow the mounting plate 202 (and/or an attached object) to rotate (e.g., pivot) relative to the pivot bracket 204.

The screws 291 may couple the pivot bracket 204 to the tilt brackets 208, 209. The tilt bolts 235 may each include a keyed head (to interface with the coupler 222), may each include a keyed shaft (to align with keyed washers of the tilt hardware 229, 233), a smooth shaft portion (to allow rotation of the tilt brackets 208, 209), and may each include a threaded shaft portion (to hold respective nuts of the outer tilt hardware 229). The tilt bolts 235 and tilt hardware 229, 233 may couple the coupler 222 to the tilt brackets 208, 209 and allow the tilt brackets 208, 209 (and/or the pivot bracket 204) to rotate (e.g., tilt) relative to the coupler 222. Tilt springs 231 may provide mechanical support (e.g., tension) to the tilt brackets 208, 209. In some examples, a component(s) (e.g., the tilt brackets 208, 209, the tilt hardware 229, 233, and/or the coupler 222) may include a mechanical feature(s) (e.g., surface(s), etc.) to limit a tilt range (e.g., ±15°, ±20°, ±30°, ±45° etc.).

The coupler 222 may include a notch 237 to accommodate the pivot hardware 227 (e.g., a nut and/or washer(s) of the pivot hardware 227). In some examples, the coupler 222 may include a keying feature(s) (e.g., recesses, notches, ridges, etc.) to align with a complementary keying feature(s) of the coupler sleeve 224. For instance, the coupler sleeve 224 may slidably engage with the coupler 222. In some examples, the coupler 222 may include a holding feature(s) (e.g., snap-fit tabs) to engage with a complementary holding feature(s) of the coupler sleeve 224. For instance, tabs protruding from the sides of the coupler 222 may engage with slots of the coupler sleeve 224 to hold the coupler 222 and coupler sleeve 224 together when assembled.

In some examples, the coupler sleeve 224 may include a lever 241 (e.g., quick-release feature) loaded with a spring 239. The lever 241 may engage with a mounting socket of a support to hold the mount 207 on the support (when assembled).

In some examples, the cover 226 may be disposed over the depression 210. For instance, the cover 226 may partially or completely cover components of an adjustment mechanism (e.g., interface plates 223, pivot rings 225, pivot bracket 204, pivot hardware 227, screws 291, tilt brackets 208, 209, tilt hardware 229, 233, springs 231, and/or tilt bolts 235). A component(s) of the adjustment mechanism (e.g., interface plates 223, pivot rings 225, pivot bracket 204, pivot hardware 227, screws 291, tilt brackets 208, 209, tilt hardware 229, 233, springs 231, and/or tilt bolts 235) may be disposed within the depression 210. For instance, the cover 226 may sit approximately flush with the upper surface of the mounting plate 202. The coupler 222 and/or the coupler sleeve 224 may protrude through a slot 243 in the cover 226. In some examples, the cover 226 may include an attachment feature(s) (e.g., snap fit feature(s)) to attach the cover 226 to the pivot bracket 204 and/or interface plates 223.

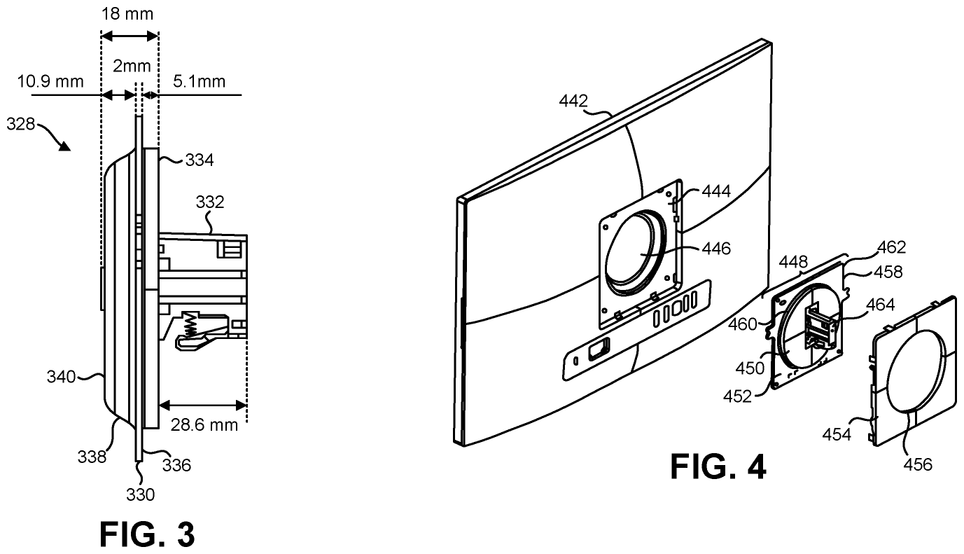

FIG. 3 is a diagram illustrating a side elevation view of an example of a mount 328. The mount 328 may be an example of the mount 101 described in relation to FIG. 1 and/or the mount 207 described in relation to FIG. 2. The mount 328 may include a mounting plate 330, an adjustment mechanism, a coupler sleeve 332, and/or a cover 334. The mounting plate 330, adjustment mechanism, coupler sleeve 332, and/or cover 334 may be examples of corresponding components described in relation to FIG. 1 and/or FIG. 2. The mounting plate 330 may include a first level 336 (e.g., a level including mounting holes, a level including a top or outer surface, etc.).

The mounting plate 330 may include a depression 338. The adjustment mechanism may be disposed in the depression 338. The mounting plate 330 may include a second level 340 (e.g., a lower level, an inner surface, etc.). The cover 334 may cover the depression 338 from a back side of the mounting plate 330.

In some examples, the cover 334 may have a thickness of approximately 5.1 mm. The coupler sleeve 332 may protrude through the cover 334. In some examples, the coupler sleeve 332 may protrude above a top surface of the cover 334 by approximately 28.6 mm. In some examples, the mounting plate 330 may have a sheet thickness of approximately 2 mm (e.g., the first level may have a thickness of 2 mm). The mounting plate 330 may have a thickness of approximately 12.9 mm from a bottom surface of the mounting plate 330 (e.g., from a bottom surface of the depression 338 and/or second level 340) to a top surface of the mounting plate 330 (e.g., to a top surface of the first level 336). In some examples, the mount 328 may have a thickness of approximately 18 mm from the bottom surface of the mounting plate 330 to a top surface of the cover 334. While some examples of dimensions are given, a different dimension(s) may be utilized in some examples.

FIG. 4 is a diagram illustrating a back perspective view of an example of a display housing 442, a mount 448, a first cover 454, and a second cover 450. The mount 448 may be an example of the mount 101 described in relation to FIG. 1, an example of the mount 207 described in relation to FIG. 2, and/or an example of the mount 328 described in relation to FIG. 3.

The mount 448 may include a mounting plate 458. The mounting plate 458 may include a first level 452. When assembled, the first level 452 may be disposed in a recess 444 (e.g., at a first depth from a backmost surface) of the display housing 442. The first level 452 may include mounting holes (e.g., mounting hole 462) to attach the mounting plate 458 to the display housing 442 (with screws and/or fasteners, for instance). In some examples, the first level 452 may be disposed under the first cover 454. For instance, the first level 452 may be disposed under the first cover 454 when the mount 448 and the first cover 454 are assembled with the display housing 442. The first cover 454 may be disposed over a first depth of the recess 444.

The mounting plate 458 may include a second level (e.g., second level 340) of a depression 460 of the mounting plate 458. In some examples, the second level may be disposed under a second cover 450. For instance, the depression 460 and/or second level may be disposed under the second cover 450.

In some examples, the second level may be disposed in a well 446 of the recess 444. For instance, the display housing 442 may include a recess 444 in a back surface of the display housing 442. The recess 444 may include a well 446, which may be a further indent and/or depression into the recess 444 (e.g., into the display housing 442). For instance, the well 446 may be a portion of the recess 444 that is indented to a greater depth (e.g., at a second depth from a backmost surface) than another portion of the recess 444. In some examples, the recess 444 and/or well 446 may be disposed into the display housing 442 towards a front side (e.g., display side) of the display housing 442.

In some examples, the mount 448 may include an adjustment mechanism. The adjustment mechanism may be disposed in the depression 460 of the mounting plate 458 and/or may be disposed under the second cover 450. In some examples, the mount 448 may include a coupler 464 coupled to the adjustment mechanism. The coupler 464 may protrude through the second cover 450. In some examples, the second cover 450 may be disposed in and/or through a window 456 of the first cover 454. For instance, a back surface of the second cover 450 may be approximately flush with a back surface of the first cover 454 when assembled. In some examples, the second cover 450 may move with an adjustment(s) of the adjustment mechanism and/or mounting plate 458.

FIG. 4 may provide an example of a first mounting arrangement. In the first mounting arrangement, the mounting plate 458 is concealable in the display housing 442. For instance, the mount 448 (and/or mounting plate 458) may be mountable to the display housing 442 without a separate adapter and/or intervening bracket.

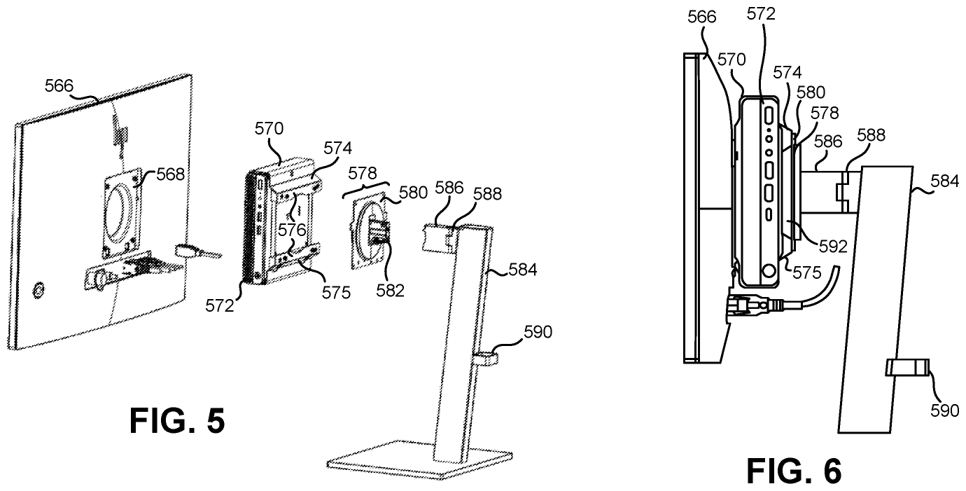

FIG. 5 is a diagram illustrating an exploded back perspective view of an example of a display housing 566, a device holding bracket 570, a device 572, a mount 578, and a stand 584. FIG. 6 is a diagram illustrating a side elevation view of the components of FIG. 5. FIG. 5 and FIG. 6 are described together. The mount 578 may be an example of the mount 101 described in relation to FIG. 1, an example of the mount 207 described in relation to FIG. 2, and/or an example of the mount 328 described in relation to FIG. 3. The mount 578 may include an adjustment mechanism disposed within a depression of a mounting plate 580.

In some examples, the display housing 566 may be included in a display device. For instance, the display housing 566 may house a display panel (e.g., light emitting diode-liquid crystal display (LED-LCD) monitor panel, organic light emitting diode (OLED) panel, etc.). In some examples, the display housing 566 may include a port(s). Examples of ports may include a DisplayPort™ (DP) socket, a High-Definition Multimedia Interface (HDMI®) socket, a Universal Serial Bus (USB) socket, a Lightning® socket, a Digital Visual Interface (DVI) socket, an optical-copper link (OCuLink) socket, and/or an Ethernet socket, etc.

The mount 578 may be compatible with a first mounting arrangement and a second mounting arrangement. An example of the first mounting arrangement is described in relation to FIG. 4. For instance, a mounting plate 580 may be concealable in the display housing 566 in the first mounting arrangement. The mounting plate 580 may be disposed outside of the display housing 566 (e.g., uncovered) in the second mounting arrangement. FIG. 5 and FIG. 6 illustrate examples of the second mounting arrangement.

A device holding bracket 570 may be utilized to mount a device 572 (e.g., electronic device, mini computer, etc.) to a back side of the display housing 566. A device 572 may be slidably inserted into the device holding bracket 570 from a lateral direction and/or the device holding bracket 570 may partially wrap around a housing of the device 572. For instance, the device holding bracket 570 may have a closed front side and a separation at a back side. A region in the device holding bracket 570 to hold a device (e.g., a region that is occupied by the device 572 when assembled) may be referred to as a device holding region. In some examples, a portion of the front side of the device holding bracket 570 may be distanced from the device holding region. For instance, the device holding bracket 570 may form a space between a portion of the front side of the device holding bracket 570 and the device 572, which may accommodate fastener heads, allow increased heat dissipation, and/or enhance ease of assembly.

The device holding bracket 570 may be coupled to the display housing 566. For instance, the device holding bracket 570 may include a front side to couple to the display housing 566. In some examples, the front side of the device holding bracket 570 may include mounting holes to fasten the device holding bracket 570 to the display housing 566 (using a fastener(s) and/or screw(s), for example). In some examples, the mounting holes of the front side of the device holding bracket 570 may be disposed at the corners of a rectangular pattern (e.g., VESA pattern). For instance, the mounting holes of the front side of the device holding bracket 570 may have a similar pattern as the mounting holes of the mounting plate 580. In some examples, the device holding bracket 570 may be coupled to the display housing 566 by placing screws through the front side of the device holding bracket 570 (when the device 572 is not inserted, for example) and into corresponding holes in the display housing 566 (e.g., in the recess 568). In some examples, a spacer(s) (with holes to accommodate screws, for instance) may be disposed between the device holding bracket 570 and the display housing 566 (e.g., in the recess 568).

In the second mounting arrangement, for instance, the mounting plate 580 may be attached to the device holding bracket 570 (which may be coupled to the display housing 566, for example). The device holding bracket 570 may include extensions 574, 575 (e.g., protrusions) away from the device holding region to accommodate the depression 592 of the mount 578 (e.g., of the mounting plate 580). In some examples, the mounting plate 580 may attach between respective lips 576 of the extensions 574, 575. For instance, the mounting plate 580 may bridge the separation of the back side of the device holding bracket 570. In some examples, the mounting plate 580 may be attached to the device holding bracket 570 (e.g., lips 576) using a fastener(s) (e.g., screws). For instance, the back side of the device holding bracket 570 (e.g., lips 576) may include holes corresponding to the mounting holes of the mounting plate 580. In some examples, the holes in the back side of the device holding bracket 570 may be disposed at the corners of a rectangular pattern (e.g., VESA pattern) corresponding to the pattern of the mounting holes of the mounting plate 580. In some examples, a first level of the mounting plate 580 may be exposed (e.g., uncovered) in the second mounting arrangement.

In some examples, the mount 578 may include a coupler and/or coupler sleeve 582. For instance, the coupler and/or coupler sleeve 582 may be inserted into a mounting socket 586 of a stand 584. In some examples, the mount 578 may provide a tilt adjustment capability and/or pivot adjustment capability, and the stand 584 (e.g., a hinge 588) may provide swivel adjustment capability and/or height adjustment capability.

In some examples, the stand 584 may include a guide 590 (e.g., clip) to route a cable(s) from the display device and/or from the device 572. Mounting the device 572 directly behind the display housing 566 may allow a cable(s) to be concealed behind the display housing 566 and/or behind the stand 584.

In some examples, to transition from the first mounting arrangement to the second mounting arrangement, a mounting plate cover may be removed from the display housing 566 and the mount 578 may be removed (e.g., unfastened) from the recess 568. The device holding bracket 570 may be attached (e.g., fastened) to the display housing 566. The device 572 may be inserted into (e.g., fastened to) the device holding bracket 570. The mount 580 may be attached (e.g., fastened) to the device holding bracket 570. The mount 580 may be attached to the stand (e.g., the coupler and/or coupler sleeve 582 may be inserted into the mounting socket 586 of the stand 584).

Some examples of the techniques, structures, and/or mechanisms described herein may allow mounting objects without a separate VESA adapter. Some examples may allow expandability by allowing a device to be mounted behind a display housing and/or may reduce an amount of table space occupied by a device and the display housing. Some examples may reduce the visibility of device cables. Some examples may reduce an amount of packaging volume utilized to package and/or ship a display housing with a stand.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, aspects or elements of the examples described herein may be omitted or combined.

What is claimed is:

1. A mount, comprising:
a mounting plate comprising mounting holes disposed in a rectangular pattern on the mounting plate to mount a device to the mounting plate;
an adjustment mechanism disposed within a depression of the mounting plate; and
a coupler to couple the mounting plate to a support.

2. The mount of claim 1, wherein the mounting holes conform to a Video Electronics Standards Association (VESA) profile.

3. The mount of claim 1, wherein the adjustment mechanism comprises tilt brackets disposed within the depression of the mounting plate.

4. The mount of claim 1, wherein the adjustment mechanism comprises a pivot bracket disposed within the depression of the mounting plate.

5. The mount of claim 4, wherein the pivot bracket is attached to two tilt brackets.

6. The mount of claim 1, wherein the coupler is coupled to the adjustment mechanism.

7. The mount of claim 6, further comprising a coupler sleeve disposed on the coupler, wherein the coupler sleeve is to interface with the support.

8. The mount of claim 1, further comprising a cover disposed over the depression to cover the adjustment mechanism.

9. The mount of claim 8, wherein the coupler is disposed through the cover.

10. A mount, comprising:
a mounting plate comprising:
a first level to be disposed in a recess of a display housing, the first level having mounting holes to attach the mounting plate to the display housing, and the first level to be disposed under a first cover; and
a second level of a depression of the mounting plate to be disposed in a well of the recess, the second level to be disposed under a second cover.

11. The mount of claim 10, further comprising an adjustment mechanism to be disposed in the depression of the mounting plate and under the second cover.

12. The mount of claim 11, further comprising a coupler coupled to the adjustment mechanism, the coupler to protrude through the second cover.

13. A mount, comprising:
a mounting plate compatible with a first mounting arrangement and a second mounting arrangement, wherein the mounting plate is concealable in a display housing in the first mounting arrangement and the mounting plate is disposed outside of the display housing in the second mounting arrangement; and
an adjustment mechanism disposed within a depression of the mounting plate.

14. The mount of claim 13, wherein in the second mounting arrangement, the mounting plate is attached to a device holding bracket that is coupled to the display housing, wherein the device holding bracket comprises extensions away from a device holding region to accommodate the depression.

15. The mount of claim 14, wherein the device holding bracket comprises a front side to couple to the display housing, and wherein the mounting plate is to attach between respective lips of the extensions.
